(19) United States
(12) Patent Application Publication
(10) Pub. No.: US 2017/0111821 A1
(43) Pub. Date: Apr. 20, 2017

(54) DISTRIBUTED LOAD BALANCING FOR ACCESS POINTS

(71) Applicant: Relay2, Inc., Milpitas, CA (US)

(72) Inventors: Guharajan Sivakumar, Bangalore (IN); Pramod Babu Gummaraj, Bangalore (IN); Privinesh Kunhikannan, Vellikulangara Orkatteri Post (IN); RaviKiran Mattaparti, Bangalore (IN)

(73) Assignee: RELAY2, INC., Milpitas, CA (US)

(21) Appl. No.: 14/886,636

(22) Filed: Oct. 19, 2015

(51) Int. Cl. H04W 28/08; H04W 28/02; H04W 48/20; H04W 72/04

(52) U.S. Cl. CPC H04W 28/08; H04W 72/0426; H04W 28/0236; H04W 48/20

(57) ABSTRACT

Balancing loads across access points in a wireless environment may be achieved based on weighting, for each of a set of access points, one or more factors including but not limited to visibility and distance of a given client relative to a given access point, congestion and CPU load of a given access point, number of connected clients, and relative received signal strength indication, according to certain embodiments.

### TECHNICAL FIELD

The present invention is directed to wireless communications, and more specifically to aspects of WiFi network architecture and services.

### BRIEF DESCRIPTION OF THE DRAWINGS

The patent or application file contains at least one drawing executed in color. Copies of this patent application publication with color drawing(s) will be provided by the Office upon request and payment of the necessary fee.

FIG. 1 is a high-level network diagram showing aspects of a distributed load balancing solution, according to certain embodiments.

FIG. 2 is a high-level flow chart that illustrates some of the functions of a current AP that receives a probe request, according to certain embodiments.

FIG. 3 is a high-level flow chart that illustrates some of the operations of the client load balance server, according to certain embodiments.

FIG. 4 is a high-level flow chart that illustrates some of the features of the ranking operation for ranking the APs, according to certain embodiments.

FIG. 5 is a graph that illustrates aspects of the ranking logic used for load balancing clients across APs in a wireless environment, according to certain embodiments.

FIG. 6 is a high-level flow chart that illustrates some aspects of the decision logic engine used by the current AP, according to certain embodiments.

FIG. 7 is a graph that illustrates aspects of the decision logic used for load balancing clients across APs in a wireless environment, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, in high density wireless environments where there may be a large number of wireless client devices that are competing for access points, load balancing across access points in the wireless environment may be achieved using a cloud based, controller-less, distributed solution, according to certain embodiments.

According to certain embodiments, a distributed solution of load balancing across access points has a faster convergence rate than non-distributed solutions.

According to certain embodiments, a distributed solution of load balancing across access points obviates a single point of failure.

According to certain embodiments, a distributed solution of load balancing across access points reacts more efficiently to changes in the wireless environment.

According to certain embodiments, a distributed solution of load balancing across access points in a cloud based, controller-less wireless environment helps reduce capital expenditure, operational expenditure and reduces complexity of the wireless environment.

According to certain embodiments, a distributed solution of load balancing includes using at least of subset of the following:
a) Visibility of a wireless client device (also referred to as a “client”) to one or more access points in the wireless environment;
b) Distance of the client from an access point;
c) Congestion in the channel associated with the access point;
d) CPU load of an access point;
e) Number of existing clients connected to an access point;
f) Received Signal Strength Indication (“RSSI”) of the client as seen by an access point.

According to certain embodiments, when a client would like to connect to an access point, the client (also referred to as a “requesting client”) sends, to access points that are nearby, a probe request to connect. According to certain embodiments, each access point that receives a probe request from the requesting client obtains information on the best access point for connecting to the requesting client.

According to certain embodiments, an access point decides to respond to the requesting client based on at least the information on the best access point for connecting to the requesting client. According to certain embodiments, an access point decides to respond to the requesting client based on one or more criteria from a set of predetermined criteria. According to certain embodiments, examples of the predetermined criteria can include but are not limited to: a channel congestion weighting factor, a number of connected clients weighting factor, a CPU weighting factor, an acceptance weight threshold.

According to certain embodiments, a load balancer maintains a list (that is associated with a given requesting client) of access points for ranking (also referred to as a “ranking list’). According to certain embodiments, the load balancer ranks the ranking list of access points as a function of a channel congestion, a CPU usage and number of connected clients of a given AP.

According to certain embodiments, the load balancer ranks APs in the ranking list in view of each AP's deviation from the worst case value for each parameter of a predetermined set of parameters.

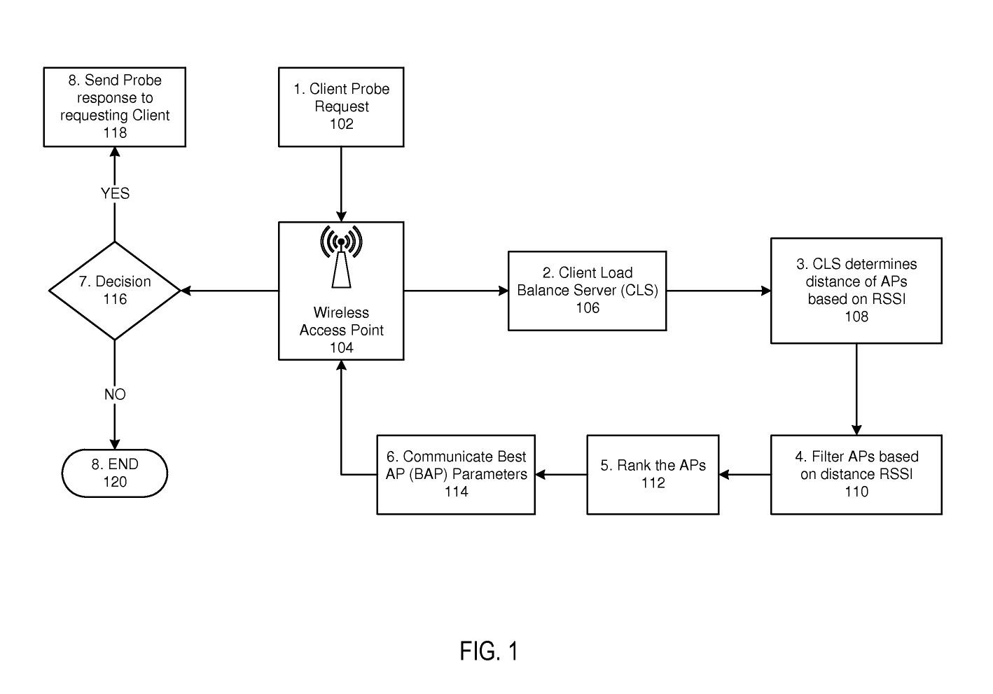

FIG. 1 is a high-level network diagram showing aspects of a distributed load balancing solution, according to certain embodiments. In FIG. 1, a client 102 (also referred to as “a requesting client”) that wishes to connect to the best access point (or connect to a suitable access point) sends a request probe to each wireless access point that is nearby the requesting client, according to certain embodiments. Each access point that receives a probe request is also referred to as a “current AP”.

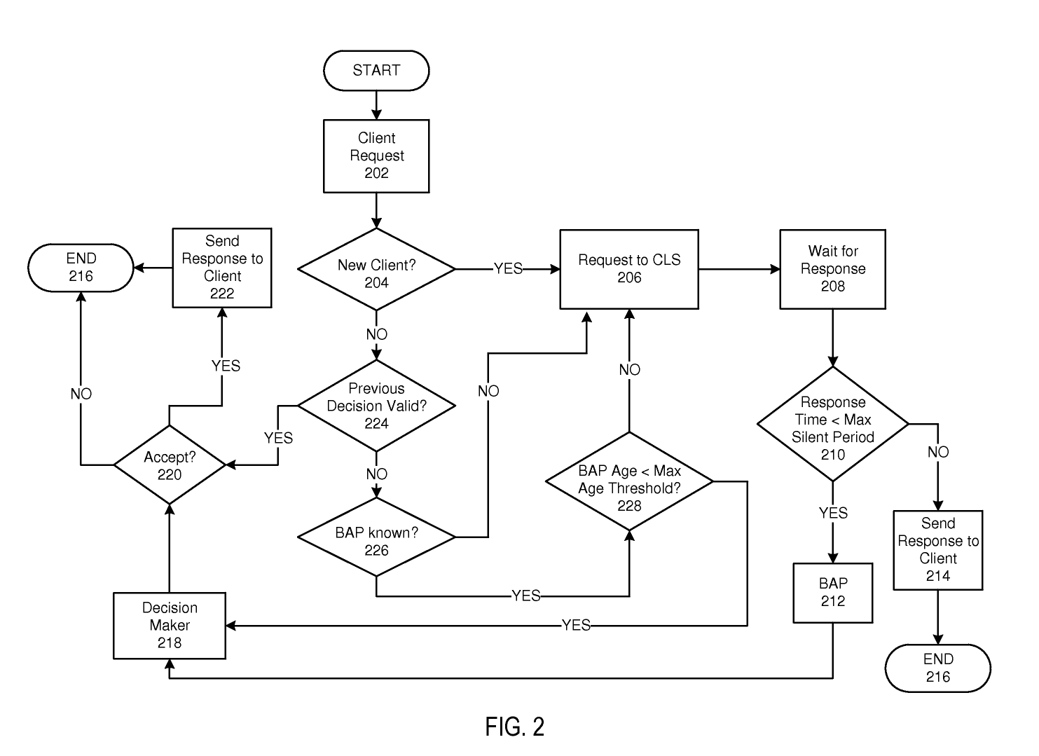

In FIG. 1, according to certain embodiments, current AP 104 communicates with a client load balance server 106. Certain aspects of current AP 104 are described in greater detail with reference to at least FIG. 2, herein.

In FIG. 1, according to certain embodiments, client load balance server 106 determines (108) the distance of the current AP 104 from requesting client 102 based on the received signal strength indication (RSSI) of requesting client 102 as perceived by current AP 104.

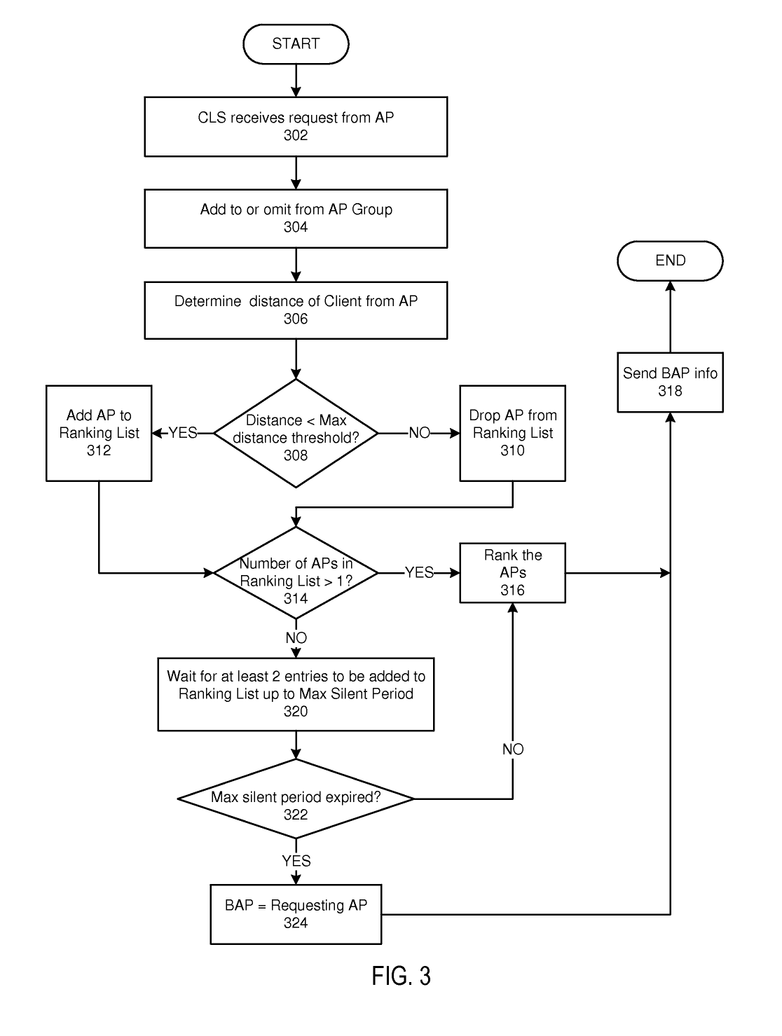

In FIG. 1, according to certain embodiments, client load balance server 106 maintains a group of APs for each requesting client and determines if the current AP 104 is to be added (110), based on the RSSI of the requesting client 102, to a “ranking list” associated with requesting client 102. Certain aspects of the client load balance server 106 are described in greater detail with reference to at least FIG. 3, herein.

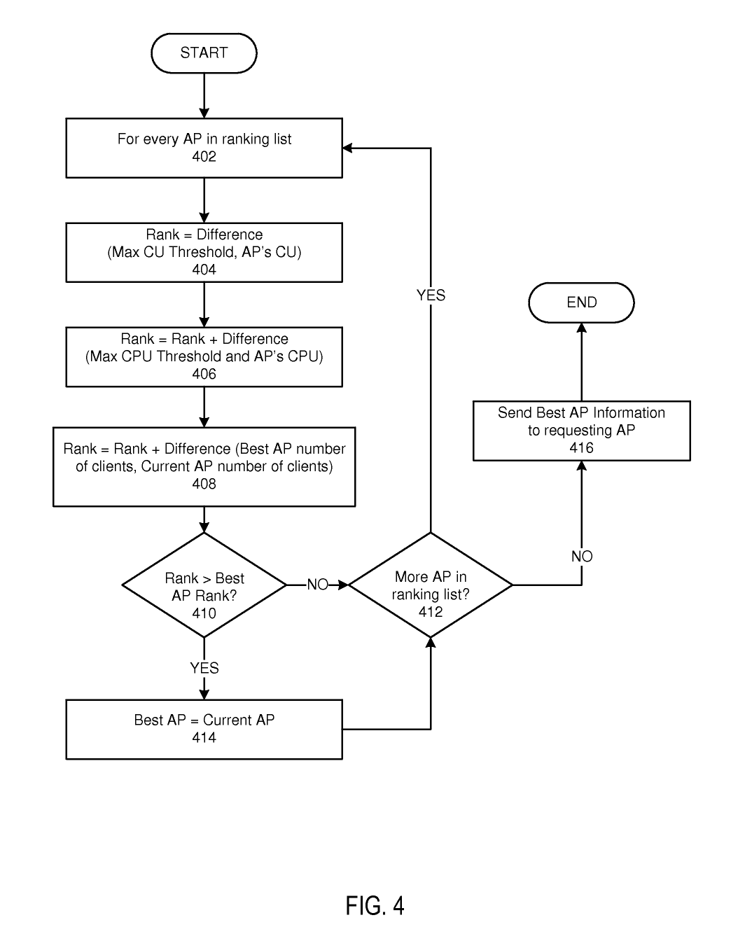

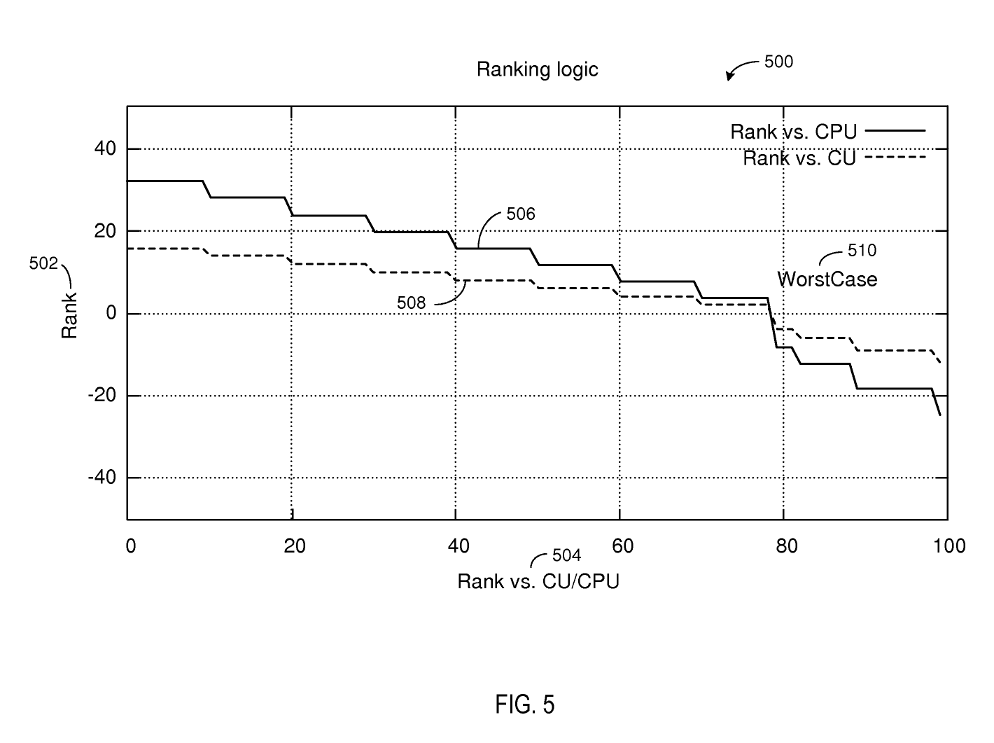

In FIG. 1, according to certain embodiments, client load balance server 106 ranks (112) the APs in the ranking list associated with requesting client 102 to determine the best AP (“BAP”). Certain aspects of the ranking process are described in greater detail with reference to at least FIG. 3, FIG. 4 and FIG. 5, herein.

In FIG. 1, according to certain embodiments, client load balance server 106 communicates (114) information on a set of parameters of the BAP to current AP 104.

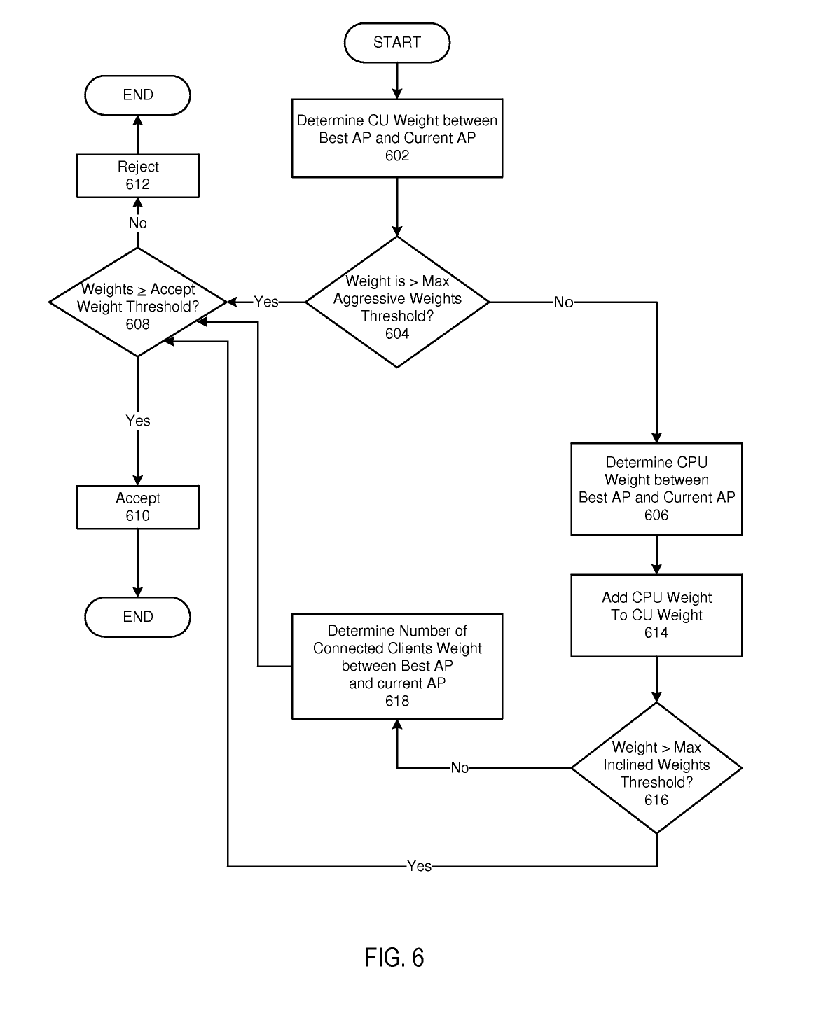

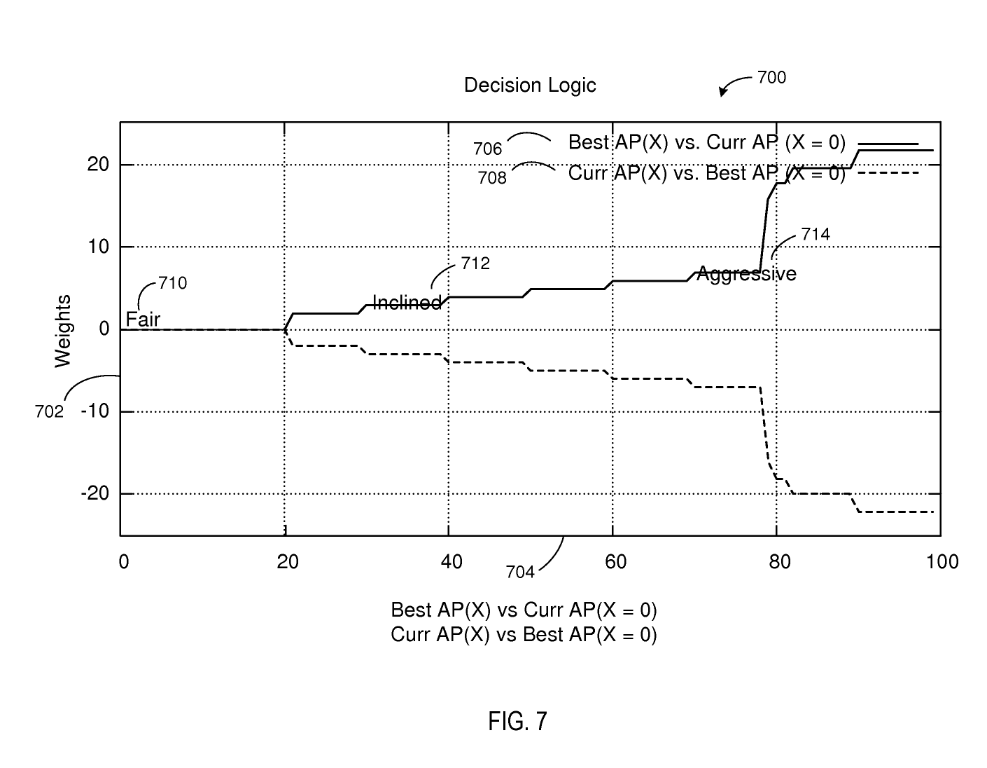

In FIG. 1, according to certain embodiments, a decision logic engine decides (116) whether to send a response (118) to the requesting client 102 or not to send a response (120) to the requesting client 102. Certain aspects of such a decision process are described in greater detail with reference to at least FIG. 6, and FIG. 7, herein.

According to certain embodiments, the process described with reference to FIG. 1 occurs for each of the nearby APs that receive the request probe from the requesting client 102.

FIG. 2 is a high-level flow chart that illustrates some of the functions of a current AP that receives a probe request, according to certain embodiments. In block 202, the current AP receives a probe request from a requesting client.

At block 204, the current AP determines if the requesting client is a new client. If the current AP determines that the requesting client is a new client, then at block 206, the current AP sends a request to client load balance server (also referred to as a “CLS”) to find the best access point (BAP) for the requesting client. According to certain embodiments, along with the request to find BAP, the current AP sends at least a subset of the following information to the CLS: 1) RSSI of the requesting client as seen by the current AP, 2) current channel congestion (or channel utilization, “CU”) associated with the current AP, 3) current CPU utilization of the current AP, 4) the number of clients connected to the current AP, 5) media access control address (MAC address) of the current AP, and 6) media access control address (MAC address) of the requesting client.

At block 208, the current AP waits for a response from the CLS for up to a predetermined maximum silent period, according to certain embodiments. At block 210, it is determined if the time for receiving a response from the CLS is less than the predetermined maximum silent period.

According to certain embodiments, the CLS determines the identity of the BAP and related information (BAP parameters) in response to the current AP's request referred to at block 206. According to certain embodiments, the determination of the identity of the BAP and related BAP parameters is described in greater detail with reference to at least FIGS. 3 and 4, herein.

If the time for receiving a response from the CLS is not less than the predetermined maximum silent period, then at block 214, the current AP sends a response to the requesting client. However, if the time for receiving a response from the CLS is less than the predetermined maximum silent period, then at block 212, the current AP waits for the information on the BAP and sends such information to a decision logic engine 218. According to certain embodiments, the decision logic engine may be physically part of the current AP device. According to certain other embodiments, the decision logic engine may be remote from the current AP device. The manner in which the decision logic engine decides whether to respond to the requesting client is described in greater detail with respect to at least FIG. 6 and FIG. 7, herein.

At block 220, the current AP receives a decision from the decision logic engine and determines whether the decision logic engine has decided to accept or reject the requesting client. If it is determined that the requesting client should be accepted, the current AP sends a response to the requesting client at block 222. If it is determined that the requesting client is to be rejected, the current AP will not respond to the requesting client, according to certain embodiments.

According to certain embodiments, if at block 204, the current AP determines that the requesting client is not a new client, then at block 224, the current AP determines if the previous decision made by the decision logic engine is still valid based on how long ago the decision was made. For example, the previous decision remains valid if the age of the previous decision is less than a maximum decision age value.

If at block 224 the current AP determines that the previous decision made by the decision logic engine is still valid, then control passes to block 220 and block 220 has been described above.

If at block 224 the current AP determines that the previous decision made by the decision logic engine is not valid, then at block 226, the current AP determines if the BAP is a known BAP. If the current AP determines that the BAP is not known, then control passes to block 206 and block 206 has been previously described above.

If the current AP determines that the BAP is a known BAP, then at block 228, the current AP determines if the age of the BAP is less than a maximum age threshold. If the current AP determines that the age of the BAP is less than a maximum age threshold, then control passes to block 218 so that the decision logic engine can determine whether to accept or reject the requesting client as previously described above. If however, the current AP determines that the age of the BAP is greater than the maximum age threshold, then control passes to block 206 and block 206 has been previously described above.

FIG. 3 is a high-level flow chart that illustrates some of the operations of the client load balance server (CLS). At block 302, the CLS receives, from the current AP, the request to find the best access point (BAP) for the requesting client, as previously described with reference to at least FIG. 2 above. According to certain embodiments, along with the request to find the BAP, the CLS receives the following information from the current AP: 1) RSSI of the requesting client as seen by the current AP, 2) current channel congestion (or channel utilization percentage, “CU”) associated with the current AP, 3) current CPU utilization percentage of the current AP, 4) the number of clients connected to the current AP, 5) media access control address (MAC address) of the current AP, and 6) media access control address (MAC address) of the requesting client.

According to certain embodiments, the CLS associates a group of APs with each client that is known to the CLS. Thus, when the CLS receives, from the current AP, the request to find the best access point (BAP) for the requesting client, the CLS adds, at block 304, the current AP to the group of APs associated with the requesting client if the requesting client is previously known to the CLS. Further, at block 304, if the requesting client is not previously known to the CLS, then the CLS creates a new group of APs for the requesting client, according to certain embodiments.

At block 306, the CLS determines the distance of the requesting client from the current AP. As a non-limiting example, the distance can be determined using triangulation techniques.

At block 308, the CLS determines if the distance of the requesting client from the current AP is less than a predetermined distance threshold. If the distance is less than the predetermined distance threshold, then at block 312 the CLS adds the current AP to a ranking list associated with the requesting client. However, if the distance is not less than the predetermined distance threshold, then at block 310, the CLS omits the current AP from the ranking list associated with the requesting client, according to certain embodiments.

At block 314, the CLS determines if the number of APs in the ranking list is greater than 1. If the number of APs in the ranking list is greater than 1, then at block 316, the CLS ranks the AP in the list. The manner of ranking is described in greater detail with reference to at least FIG. 4 and FIG. 5, herein, according to certain embodiments. Such a ranking identifies the best AP (BAP). At block 318, the CLS sends information of the BAP, such as the identity of the BAP and other BAP parameters, to the current AP.

According to certain embodiments, the BAP information includes at least a subset of: 1) RSSI of the requesting client as seen by BAP, 2) channel utilization percentage associated with BAP, 3) BAP CPU utilization percentage, 4) the number of clients connected to BAP, 5) media access control address (MAC address) of BAP, and 6) media access control address (MAC address) of the requesting client.

If at block 314, the CLS determines that the number of APs in the ranking list is not greater than 1, then at block 320, the CLS waits for more APs to make request for BAPs. According to certain embodiments, the CLS waits for a period up to a predetermined maximum silent period.

At block 322, the CLS determines if the predetermined maximum silent period has expired. If the predetermined maximum silent period has expired then at block 324, the CLS designates the current AP as BAP and sends the BAP information to the current AP at block 318 as previously described.

If the predetermined maximum silent period has not expired then controls passes to block 316 and block 316 is previously described above.

FIG. 4 is a high-level flow chart that illustrates some of the features of the ranking operation for ranking the APs, according to certain embodiments. The higher the AP's rank, the better the AP. At block 402, the CLS considers each AP in the ranking list in view of each AP's deviation from the worst case value for each parameter of a predetermined set of parameters, as described with reference to blocks 404, 406, 408 of FIG. 4.

At block 404, for each current AP, the CLS determines the absolute value of the difference between channel utilization maximum threshold value and current AP channel utilization.

At block 406, for each current AP, the CLS determines the absolute value of the difference between CPU usage max threshold value and current AP CPU usage adds it to the result of block 404.

At block 408, for each current AP, the CLS determines the absolute value of the difference between number of clients connected to the best AP and the number clients connected to the current AP and adds it to the result of block 406. According to certain embodiments, the result of block 408 is the rank of the respective current AP.

At block 410, the CLS determines if the current AP has a rank that is greater than the rank of the best AP thus far. If the CLS determines that the current AP's rank is greater than the best rank, then at block 414, the CLS designates the current AP as the BAP. Next control passes to block 412 which is described below.

If at block 410, the CLS determines that the current AP's rank is not greater than the rank of the best AP thus far, then at block 412, the CLS determines if there are more APs in the rank list. If there are no more APs in the rank list, then at block 416, the CLS sends the BAP information to the current AP. If there are more APs in the rank list then control passes back to block 402 to determine the rank of the next current AP.

According to certain embodiments, the APs in the ranking list are ranked as follows based on empirical analysis:

Rank=(Δx/10)+((2+(K/3)*2)*CUcurr/CUmax)*(Δx/10)*(Ŝ)+(Δy/10+((2+(L/3)*2)*CPUcurr/CPUmax)+Δy/10)*(Ŝ)+(RSSI/30)+(Δz)*(Ŝ), for all K>0 and L>0

and where,

(Δx)=ABS(80−CUrap)

Absolute value of the difference between channel utilization maximum threshold value and current AP channel utilization.

(Δy)=ABS(80−CPUrap)

Absolute value of the difference between CPU utilization max threshold value and current AP CPU utilization

(Δz)=ABS(NCbest−NCrap)

Absolute value of the difference between number of clients connected to the best AP and the number clients connected to the current AP.

And where, the sign factor (S):

(Ŝ)=((comparing value−current value)>0), if current value is greater than the comparing value, the sign factor is true. If the sign factor is true, the calculated value will be negative. For example, if the current AP channel utilization is 83 and CUmax is 80, the sign factor will be true and will pull the results toward the negative scale.

K=(CUcurr−CUmax)

L=(CPUcurr−CPUmax)

FIG. 5 is a graph that illustrates aspects of the ranking logic used for load balancing clients across APs in a wireless environment, according to certain embodiments. Ranking logic graph 500 of FIG. 5 shows Rank 502 as the vertical axis and Rank vs channel utilization/CPU utilization (CU/CPU) 504 as the horizontal axis. Graph 500 also shows the rank vs CPU plot 506 and the rank vs CU plot 508. Graph 500 also shows the worst case value 510 based on the example above. To explain, the current APs are ranked based on the respective current AP's deviation from the worst case value for each parameter of a predetermined set of parameters, according to certain embodiments. As non-limiting examples, the parameters include channel utilization, CPU utilization and number of connected clients, according to certain embodiments.

FIG. 6 is a high-level flow chart that illustrates some aspects of the decision logic engine used by the current AP (when the current AP receives the BAP information from the CLS) to decide whether to respond or ignore the requesting client that is requesting connection with the current AP.

According to certain embodiments, such a decision of the current AP can be any one of the following types: 1) aggressive, 2) inclined, and 3) fair. According to certain embodiments, when an aggressive decision is selected, the current AP responds immediately to the requesting client without further delay or further processing. When an inclined decision is selected, the current AP processes certain parameters as described in greater detail below. When a fair decision is selected, the current AP will attempt to divide the number of clients fairly across the current AP and the BAP.

At block 602, the decision logic engine determines a channel utilization (CU) weight between BAP and the current AP. At block 604, the decision logic engine determines if the weight determined at block 602 is greater than a predetermined maximum aggressive weight threshold value. If the weight determined at block 602 is greater than the maximum aggressive weight threshold value then, at block 608, the decision logic engine determines if the weight determined at block 602 is greater than or equal to a predetermined “accept weight” threshold value. If the weight determined at block 602 is greater than or equal to the predetermined “accept” threshold value, then at block 610 the decision status is set to “accept” (so that the current AP can send a response to the requesting client to allow the requesting client to connect to the current AP. However, if the weight determined at block 602 is not greater than or equal to the predetermined “accept” threshold value, then at block 612 the decision status is set to “reject” (so that the current AP can ignore the requesting client probe request).

Further, if at block 604, the decision logic engine determines that the weight determined at block 602 is not greater than the predetermined maximum aggressive weight threshold value, then at block 606, the decision logic engine determines the CPU weight between the BAP and the current AP.

At block 614, the decision logic engine adds the CPU weight to the CU weight, according to certain embodiments. At block 616, the decision logic engine determines if the combined CPU and CU weight is greater than the maximum inclined weight threshold value. If the decision logic engine determines that the combined CPU and CU weight is greater than the maximum inclined weight threshold value, then control passes to block 608. However, if combined CPU and CU weight is not greater than the maximum inclined weight threshold value, then at block 618, the decision logic engine determines the “number-of-connected-clients” weight between the BAP and the current AP (this is the fair decision). Then at block 608, the decision logic engine determines if the weight determined at block 618 is greater than or equal to the predetermined “accept” threshold value. If the weight determined at block 618 is greater than or equal to a predetermined “accept” threshold value, then at block 610 the decision status is set to “accept” (so that the current AP can send a response to the requesting client to allow the requesting client to connect to the current AP. However, if the weight determined at block 618 is not greater than or equal to the predetermined “accept” threshold value, then at block 612 the decision status is set to “reject” (so that the current AP can ignore the requesting client probe request).

According to certain embodiments, the weight determination for each of the parameters (CU, CPU and Number of connected clients) is as follows and is based on empirical analysis.

CU Weight Determination

Weight=P+Weight+((Δx/10+((2+(K/3)*2)*b/m))+(((2+(L/3)*2)*a/m)+Δx/10))*(Ŝ)
for all a>i∥b>i∥Δx>20 and for all K>0 and L>0
The Weight will be non-zero if and only if a or b are greater than the Minimum channel utilization threshold I, (for example, i=30) or Δx>20, according to certain embodiments.
where,
P=Parameter priority
P can be either negative or positive or zero. P can be used either to increase or decrease the priority of a given parameter. The higher the value of P, the higher the priority. Default value of P is 1. The value P can be changed by the user. The value of P is unique for each parameter, according to certain embodiments.
m=Maximum threshold value of the CU
a=Current AP channel utilization
b=Best AP channel utilization
i=Minimum CU threshold

K=(b−m)

L=(a−m)
Δx=ABS(a−b), which is the absolute value of the difference between current AP channel utilization and Best AP channel utilization.
(Ŝ)—Sign factor=((b−a)>0), if current CU value is greater than the Best AP CU value the sign factor will be true. If the sign factor is true the calculated value will be negative. For example, if Current AP CU is 33 and Best AP CU is 30, the sign factor will be true.

CPU Weight Determination

Weight=P+Weight+((Δx/10+((2+(K/3)*2)*b/m))+(((2+(L/3)*2)*a/m)+Δx/10))*(Ŝ)
for all a>i∥b>i∥Δx>20 and for all K>0 and L>0
The input weight will be always a non-zero value in this equation.
P=Parameter priority
P can be either negative or positive or zero. P can be used either to increase or decrease the priority of a given parameter. The higher the value of P, the higher the priority. Default value of P is 1. The value P can be changed by the user. The value of P is unique for each parameter, according to certain embodiments.
where,
m=Max threshold value of the CPU utilization
a=Current AP CPU utilization
b=Best AP CPU utilization
i=minimum CPU threshold
P=Priority
Δx=ABS (a−b) (Absolute difference between current AP CPU utilization and Best AP CPU utilization).

K=(b−m)

L=(a−m)
(Ŝ)—Sign factor=((b−a)>0), if current CPU utilization value is greater than the best AP CPU utilization value, then the sign factor will be true. If the sign factor is true, the calculated value will be negative. For example if Current AP CPU is 33 and Best AP CPU is 30, the sign factor will be true.

Number of Connected Clients Weight Determination:

Weight=P+Weight+Δx/S*(Ŝ)+(ΔRSSI/30)
The scaling parameter (S) value will change based on the weight calculated from the previous equations used by parameters CU and CPU.
If the input weight<3
   S=1
If the input weight>3
   S=2
If the input weight>=5
   S=3
P=Parameter priority
P can be either negative or positive or zero. P can be used either to increase or decrease the priority of a given parameter. The higher the value of P, the higher the priority. Default value of P is 1. The value P can be changed by the user. The value of P is unique for each parameter, according to certain embodiments.
where,
S=Scale
a=Current AP number of connected clients
b=Best AP number of connected clients
P=Priority
Δx=ABS (a−b) (Absolute difference between current AP connected clients and Best AP connected clients).
ΔRSSI=(a−b) (A positive difference between current AP RSSI and Best AP RSSI)
(Ŝ)—Sign factor=((b−a)>0), if current AP number of connected clients value is greater than the best AP number of connected clients value, then the sign factor will be true. If the sign factor is true, the calculated value will be negative. For example if Current AP number of connected clients is 33 and Best AP number of connected clients is 30, the sign factor will be true.

FIG. 7 is a graph that illustrates aspects of the decision logic used for load balancing clients across APs in a wireless environment, according to certain embodiments. Decision logic graph 700 of FIG. 7 shows Weights 702 as the vertical axis and BAP (x) vs Curr AP (x=0) 704 as the horizontal axis. Graph 700 also shows the BAP (x) vs Curr AP (x=0) plot 706 and the Curr AP vs BAP (x=0) plot 708. Graph 500 also shows the worst case. Graph 700 also shows the Fair 710, Inclined 712, and Aggressive 714 decision logic.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A wireless communication system comprising:
a plurality of access point devices;
wherein, each current access point device of at least a first subset of the plurality of access point devices:
receives a probe request from a requesting client device;
sends a request to a client load balancer asking for a set of parameters associated with a best access point device;
receives the set of parameters associated with the best access point device; and
uses a decision logic engine to weight each parameter of at least a subset of the set of parameters.

2. The wireless communication system of claim 1, wherein the set of parameters associated with the best access point device include:
an RSSI (received signal strength indication) of the requesting client as seen by the best access point device;
a channel utilization of the best access point device;
a CPU utilization of the best access point device;
a number of clients connected to the best access point device;
a media access control address (MAC address) of the best access point device; and
a media access control address (MAC address) of the requesting client.

3. The wireless communication system of claim 1, wherein the best access point device is determined by ranking a second subset of access point devices from the plurality of access point devices, wherein the second subset of access point devices is associated with the requesting client device.

4. The wireless communication system of claim 3, wherein the second subset of access point devices is the same as the first subset of access point devices.

5. The wireless communication system of claim 3, wherein ranking is a function of:
comparing a channel utilization of the respective current access point device with a predetermined maximum channel utilization threshold value; and
comparing a CPU utilization of the respective current access point device with a predetermined maximum CPU utilization threshold value.

6. The wireless communication system of claim 3, wherein the ranking is a function of:
comparing a number of connected clients of the respective current access point device with a number of connected clients of the best access point device.

7. The wireless communication system of claim 1, wherein the request to the client load balancer includes:
an RSSI (received signal strength indication) of the requesting client as seen by the respective current access point device;
a channel utilization of the respective current access point device;
a CPU utilization of the respective current access point device; and
a number of clients connected to the respective current access point device.

8. The wireless communication system of claim 1, wherein the decision logic engine weights each parameter of the subset of parameters based on:
a predetermined maximum threshold value of channel utilization;
a predetermined minimum threshold value of channel utilization;
a channel utilization of the respective current access point device;
a channel utilization of the best access point device;
a predetermined maximum threshold value of CPU utilization;
a predetermined minimum threshold value of CPU utilization;
a CPU utilization of the respective current access point device; and
a CPU utilization of the best access point device.

9. The wireless communication system of claim 1, wherein the decision logic engine weights each parameter of the subset of parameters based on:
a number of connected clients of the respective current access point device;
a number of connected clients of the best access point device;
an RSSI of the respective current access point device; and
an RSSI of the best access point device
